(19) United States
(12) Patent Application Publication
(10) Pub. No.: US 2008/0047979 A1
(43) Pub. Date: Feb. 28, 2008

(54) Water supply cap

(76) Inventor: Hung-Ming Lee, Taipei Hsien (TW)

Correspondence Address: RABIN & BERDO, P.C., Suite 500, 1101 14 Street, N.W., Washington, DC, 20005, US

(21) Appl. No.: 11/508,214

(22) Filed: Aug. 23, 2006

(51) Int. Cl. B67D 5/06

(52) U.S. Cl. 222/185.1

(57) ABSTRACT

A “water supply cap” is a device that is assembled with a bottle that loads drinking water to dispense the drinking water after the assembled unit is placed upside down; it comprises of a stand and a support collar that is installed on top of the opening of a drinking water bottle. Combination of the stand and the support collar provides a canal to discharge the drinking water and an air channel to balance the barometric pressure inside and outside of the drinking water bottle so as to ensure smoother water discharge.

### BACKGROUND OF THE INVENTION

I. Field of the Invention

A “water supply cap” is a cap that is installed on top of the opening of a drinking water bottle so as to dispense the water; more particularly, a “water supply cap” of the invention is a structure comprising of a air channel, which balances the barometric pressure inside and outside the drinking water bottle so as to ensure smoother water discharge.

II. Description of the Prior Art

Nowadays, in consideration of drinking water quality as well as maintenance and repair costs, most enterprises utilize drinking water dispensers. Furthermore, the drinking water bottles presently on the market mainly consist of two kinds, mineral and distilled water. Mineral water, which comes from natural springs and is filtered through many crustal layers, is clean and rich in minerals that are necessary to human health. On the other hand, it is through manual processes of heating, boiling, vaporizing, cooling, and chilling that distilled water is collected. Distilled water is pure and aseptic because substances such as chlorine, trihalomethanes, and so on that cause cancer are evaporated by heat; furthermore, the bacteria and filterable viruses are sterilized by a long period of boiling; moreover, the steam precipitates the lime, rust, heavy metal, and silt.

As the name suggests, the said drinking water bottle is water packaged in a bottle and must be mounted on a water dispenser in order to dispense the water. With reference to FIG. 1, which shows the installation of a water dispenser of the prior art, one must open the bottled drinking water 10, and place it upside down to probe in the inlet 201 of the water dispenser 20. However, the packaging of drinking water bottle 10 is bulky and heavy because it is usually packaged in a large volume; consequently, its installation takes a lot of effort and is very time-consuming and is, in particular, difficult to be accomplished by women. In addition, the water dispenser 20 is not suitable for outdoor use or use in any disadvantaged places because its support frame is too big to be carried.

In view of the said drawback, a simple structure of “water supply cap” has been addressed; it possesses the advantages of easy portability and compatibility with any drinking water bottle or liquid bottle that contains such liquids as soy sauce, salad oil, dishwashing liquid, or others. Nevertheless, this structure of “water supply cap” has encountered a problem where the discharge of drinking water causes deviation of the barometric pressure inside and outside the drinking water bottle; consequently, this hinders or suspends the dispensing of water. Therefore, a further improvement in this regard is imperative.

### SUMMARY OF THE INVENTION

To achieve the foregoing objectives, the main objective of the invention is to provide an innovative “water supply cap” that has a simple structure and easy installation so as to ensure convenient use for the user.

To achieve the foregoing objective, the “water supply cap” of the invention is a structure comprising of a stand and a support collar that can be installed on top of the opening of a drinking water bottle to dispense the water. With regard to the stand, a canal is embedded inside and its two ends have respectively, a receiver, which has at least one anchor portion and several bumps on the edge, and a tap for dispensing the water. With regard to the support collar, it is installed on the opening of a drinking water bottle so as to be combined with the foregoing stand; furthermore, its outer part has at least one relative anchor and several ribs to combine with the receiver of the stand. Where the support collar combines with the stand, the drinking water is discharged through the canal and an air channel is formed to balance the barometric pressure inside and outside the drinking water bottle to achieve a smoother water discharge.

Further aspects, objects, and desirable features of the invention will be better understood from the detailed description and drawings that follow, in which the embodiment of the disclosed invention is illustrated by way of example.

### BRIEF DESCRIPTION OF THE DRAWINGS

FIG. 1 is a sectional view showing installation of the prior art.

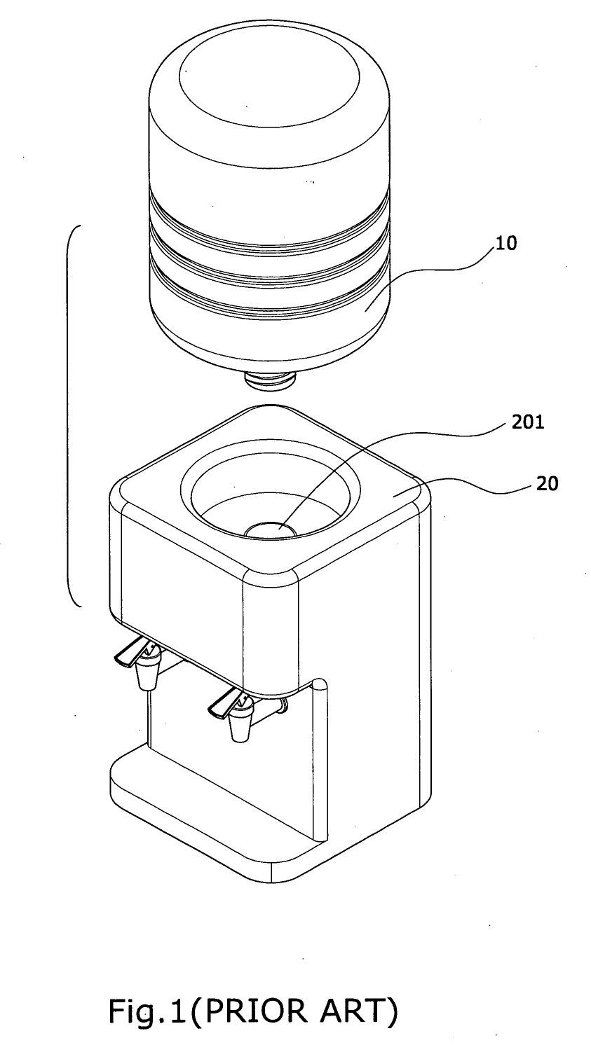

FIG. 2 is a structural view of the present invention.

FIG. 3 is a three-dimensional view of the stand of the present invention.

FIG. 4 is a three-dimensional view of the support collar of the present invention.

FIG. 5 is a sectional view showing utilization of the present invention.

FIG. 6 is a cross-sectional view showing combination of the support collar and stand of the present invention.

### DESCRIPTION OF THE PREFERRED EMBODIMENT

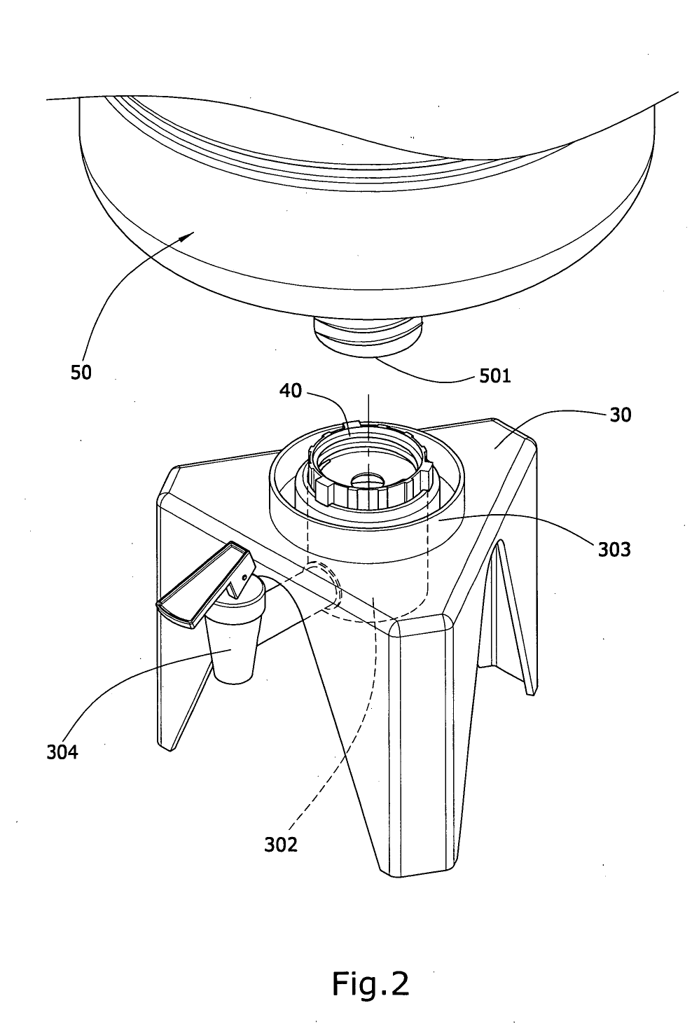

With reference to FIG. 2, which is a structural view of the invention, a “water supply cap” of the invention comprises of a stand 30, which has a canal 302 inside, and a support collar 40, which is installed on top of the opening 501 of a drinking water bottle 50. In order to assemble the “water supply cap” and the drinking water bottle for use: probe the support collar 40 in the receiver 303 of the stand 30; then place the stand 30 together with the drinking water bottle 50 upside down so that the drinking water bottle is able to rest on the stand 30; finally, the tap 304 on the stand 30 will be able to dispense the water.

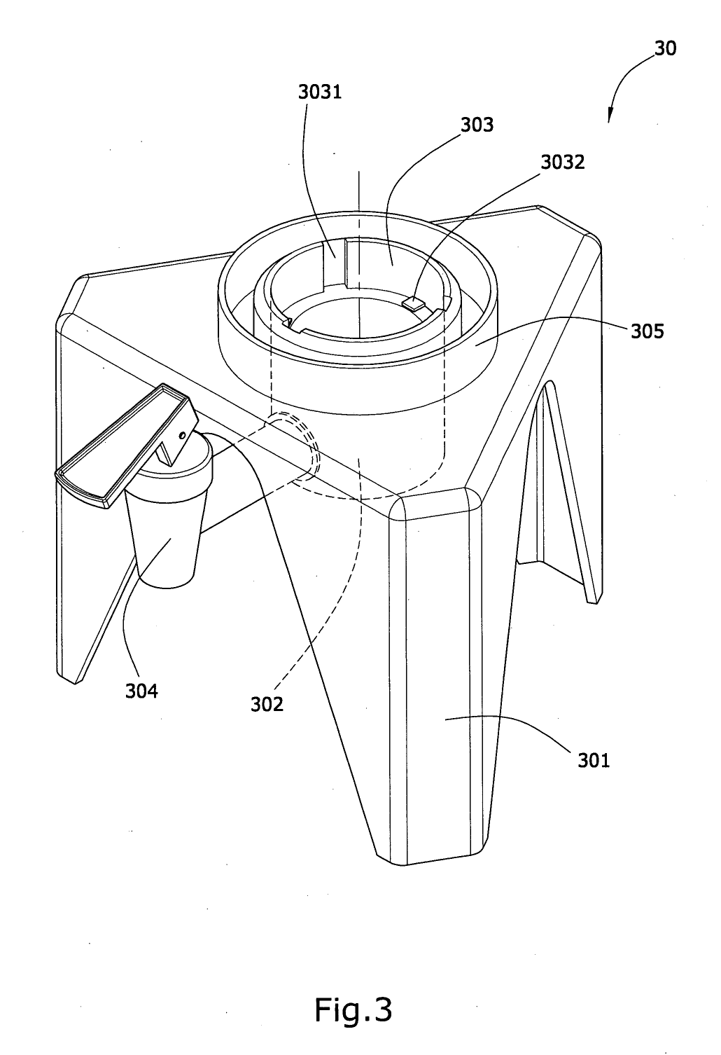

With reference to FIG. 3, which is a three-dimensional structural view of the stand of the invention, the stand 30 of the “water supply cap” has several legs 301 strong enough to support it when it is fully loaded. In addition, a canal 302, built inside the stand 30, serves as a passage to the flow of bottled drinking water; besides, one end of the canal 302 has a receiver 303 which receives the support collar 40 for combination. On the edge of the receiver 30, there is at least one anchor portion 3031, which may be a gap or convex, as well as several bumps 3032, which create a suitable gap between the stand 30 and the support collar 40 for air circulation so as to ensure smoother water discharge. Moreover, a tap 304 is installed on the other end of the canal 302 to dispense the water; it may be of a popular type currently on the market, which are operated by either pressing a button or turning a knob. Furthermore, the opening of the receiver 302 on the stand 30 is sleeved by an anti-leakage ring 305 to stop the drinking water leaking from the gap between the stand 30 and support collar 40. Without the anti-leakage ring 305, the drinking water may leak from the gap between the stand 30 and support collar 40 and leave a water stain and cause humidity in view that the drinking water bottle 50 is placed upside down to rest on the stand 30.

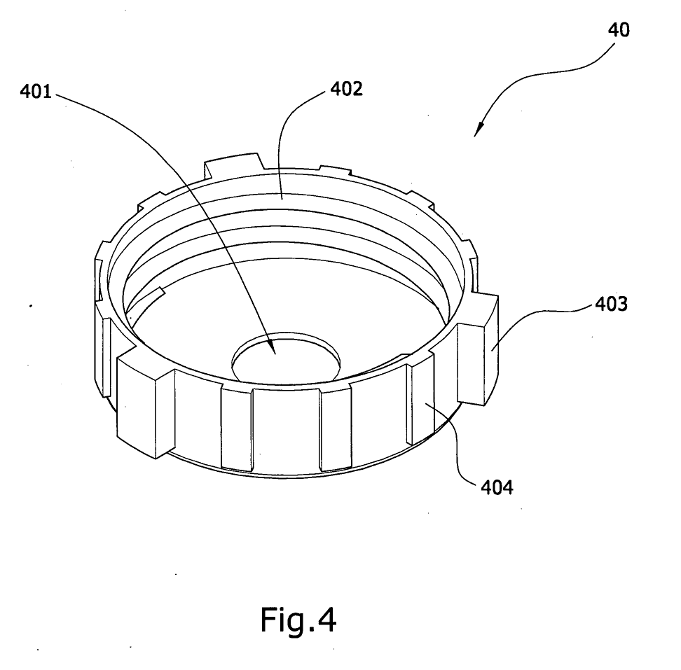

With reference to FIG. 4, which is a three-dimensional structural view of the support collar of the invention, the support collar 40 of the “water supply cap” has a central hole 401, is veined with thread 402 on its internal wall and is covered with at least one relative anchor portion 403 and several ribs 404 on its external wall. On the other hand, the opening 501 of the drinking water bottle 50 is also veined with the thread 502 on its external wall. The thread 402 corresponds to the thread 502 so as to ensure combination of the support collar 40 and the opening 501. The anchor portion 3031 of the stand 30 corresponds to the relative anchor portion 403 of the support collar 40 so as to ensure combination of the support collar 40 and the receiver 302 of the stand 30. In addition, several ribs 404 create a suitable gap between the support collar 40 and the stand 30 that allows air to enter into the drinking water bottle 50 while discharging. Under such circumstances, the barometric pressure inside and outside the drinking water bottle reach a balance and no vacuum occurs inside the drinking water bottle to hinder water discharge. When the support collar 40 is combined with the stand 30, the drinking water is thus discharged through the canal 302 for dispensing via the tap 304.

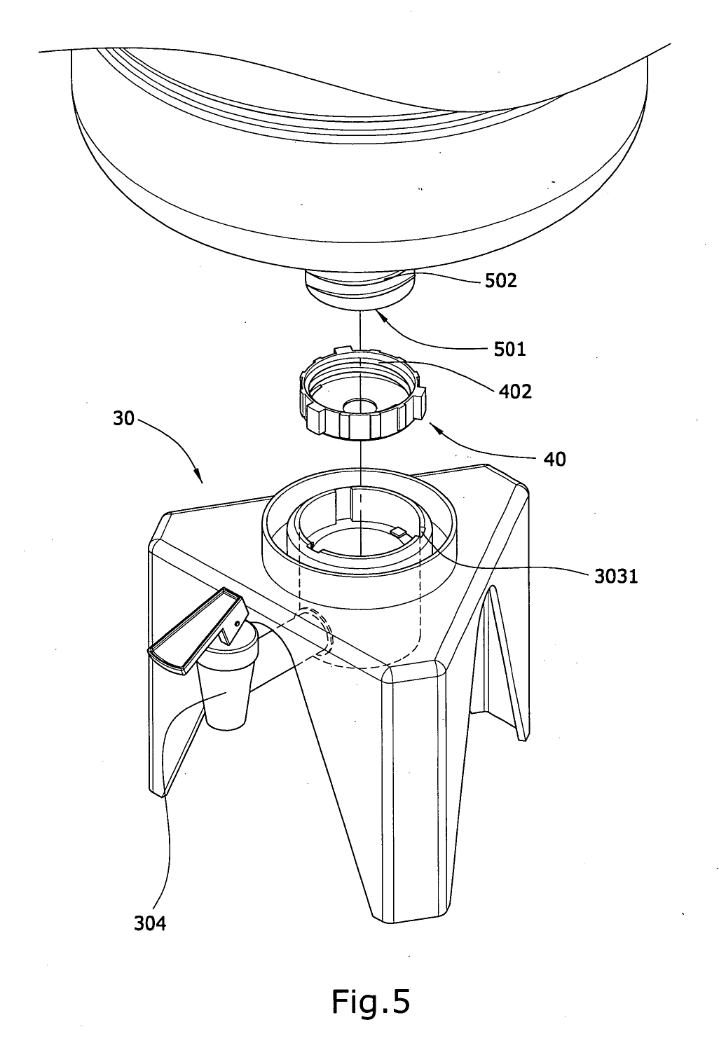

FIG. 5 is a sectional view showing utilization of the invention; firstly, install the support collar 40 on top of the opening 501 of a drinking water bottle 50 by hooking up the two corresponding threads, which are the thread 402 of the support collar 40 and the relative thread 502 of the opening 501. Secondly, attach the relative anchor portion 403 of the support collar 40 to the anchor 3031 of the stand 30 so as to form an assembly that does not rock and detach. Finally, place the assembled unit in hole upside down so that the gravity action produced by the water in the drinking water bottle 50 provides firm footing to the stand 30 on level ground and pressure to smooth the water discharge via the tap 304.

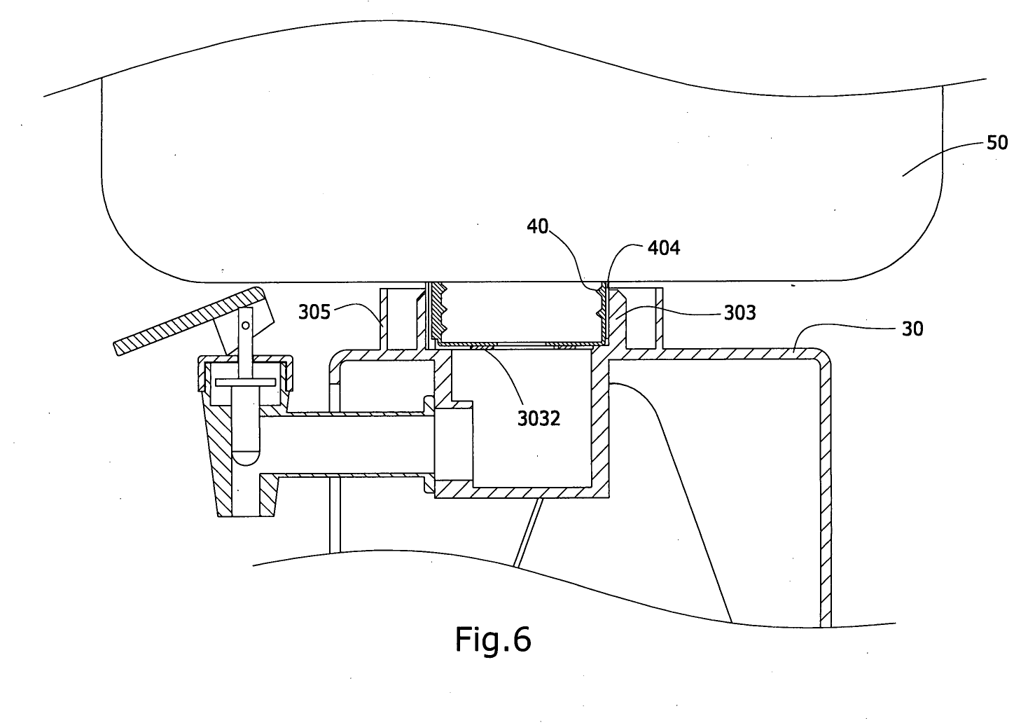

With reference to FIG. 6, which is a cross-sectional view showing combination of the support collar and the stand of the invention, prevents suspension of water supply due to vacuum in the drinking water bottle 50 while discharging, a channel for air circulation is considered indispensable and is thus embodied in the invention by forming a gap between ribs 404 of the support collar 40 and bump 3032 inside the receiver 303 of the stand 30. Where the drinking water is discharged, the said gap allows the barometric pressure inside and outside of the drinking water bottle 50 to reach a balance so as to ensure smoother water discharge. Furthermore, the receiver 303 of the stand 30 is sleeved by at least one anti-leakage ring 305 to prevent the leakage, which may leave a water stain and cause humidity to occur in the area where the water dispenser is installed.

According to the above descriptions, the “water supply cap” of the invention is embodied as follows: one can place the support collar on top of the opening of a drinking water bottle and then probe the support collar in the receiver of the stand to form a canal for discharging the drinking water as well as to form an air channel, which balances the barometric pressure inside and outside the drinking water bottle so as to ensure smoother water discharge. The embodiment proves that the “water supply cap” of the invention substantiates the water discharge with a simple structure and easy installation.

New characteristics and advantages of the invention covered by this document have been set forth in the foregoing description. Understanding is sought, however, that the drawings are for the purpose of illustration only and not intended to be a definition of the limits of the invention. Changes in methods, shapes, structures, or devices may be made in details without exceeding the scope of the invention by those who are skilled in the art. The scope of the invention is, of course, defined in the language in which the appended claims are expressed.

To sum up, the “water supply cap” of the invention has the advantages of a simple structure and easy installation so as to possess the “practicability” and “advancement” in the industry field.

What is claimed is:

1. A “water supply cap” is installed on top of a drinking water bottle for discharging water and comprises of:
A stand, which comprises of a canal internally, a receiver, on one end of the canal, and a tap on the other end of the canal. In addition, the receiver has at least one anchor portion and several bumps, which correspond to the connection surface on the support collar.
A support collar, which is installed on top of the opening of a drinking water bottle so as to combine with the stand. The support collar has a central hole inside and at least one relative anchor portion and several ribs on the external surface. The ribs correspond to the connection surface of the stand so as to ensure combination of the support collar and receiver of the stand. Combination of the support collar and stand allows the drinking water being discharged to pass through the canal and form an air channel that balances the barometric pressure inside and outside the drinking water bottle so as to ensure smoother water discharge.

2. The “water supply cap” of claim 1, wherein the stand has several legs.

3. The “water supply cap” of claim 1, wherein the anchor portion is concave and its relative anchor portion is convex.

4. The “water supply cap” of claim 1, wherein the anchor portion is convex and its relative anchor portion is concave.

5. The “water supply cap” of claim 1, wherein the claim refers to the above.

6. The “water supply cap” of claim 1, wherein the tap is a press-button type.

7. The “water supply cap” of claim 1, wherein the tap is a turn-knob type.

8. The “water supply cap” of claim 1, wherein the support collar has a thread portion on the internal wall and the thread corresponds to the thread on the opening of the drinking water bottle.

9. The “water supply cap” of claim 1, wherein at least one anti-leakage ring is installed on the opening of the receiver on the stand.
